(19) United States
(12) Patent Application Publication
(10) Pub. No.: US 2003/0142264 A1
(43) Pub. Date: Jul. 31, 2003

(54) Reading safety glasses

(76) Inventors: Roland Westerdal, Brookfield, CT (US); Chunhuang Li, Tainan (TW)

Correspondence Address: James R. Frederick, Ware, Fressola, Van Der Sluys & Adolphson LLP, 755 Main Street, Bldg. 5, P.O. Box 224, Monroe, CT, 06468, US

(21) Appl. No.: 10/253,272

(22) Filed: Sep. 23, 2002

Related U.S. Application Data
(60) Provisional application No. 60/324,159, filed on Sep. 21, 2001.

(51) Int. Cl. G02C 1/04

(52) U.S. Cl. 351/106

(57) ABSTRACT

Safety glasses have a one-piece unitary lens with a left eye plano-convex portion and a right eye plano-convex portion, each having an independent radius of curvature in the range of 5 to 8 diopters. A corrective lens segment is integrally positioned in each plano-convex portion. The corrective lens segments are preferably semi-circular with a straight upper edge and are surrounded by the plano-convex portion.

Side shields are formed integrally with the lens. A frame includes a top piece extending along the lens and side shields, and temples hinged to the top piece.

### BACKGROUND OF INVENTION

This application claims benefit of the filing date of Provisional Application S. No. 60/324,159 filed Sep. 21, 2001.

### FIELD OF THE INVENTION

The invention herein relates to safety glasses with corrective segments.

Many tasks are performed more safely while wearing safety glasses. These are typically tasks in which there may be flying debris, such as in machine shops, in manufacturing facilities, and at construction sites. In some instances, safety glasses are required by regulation.

Of course, safety glasses need to be strong and shatterproof to withstand the impact of flying debris. In order to enhance protection, it is preferred that safety glasses generally conform to the face of the wearer, with a minimal gap between the safety glasses and the cheek of the wearer. Therefore, some safety glasses are provided in a one-piece wrap around lens. The wrap around lens consists of a single unitary lens that extends over both eyes, and has a single radius of curvature that permits the lens to follow the contour of the wearer's face from the sides of the wearer's nose outwardly along the cheek bones. Integral side shields may also be included with the unitary lens.

It has been found that many wearers, including particularly some older wearers, may require correction of their vision for reading and for close work. To date, this has often been accomplished by wearing regular glasses under a protective goggle or other type of safety lens. Safety glasses with reading inserts exist in a standard frame, with two separate lenses and attached side shields. Although each lens has a curvature of between 4 and 6 diopters, these safety glasses are generally flat in front of the wearer's face. Small flexible corrective lenses have also been provided for attachment to the exterior surface of safety glasses, but it is extremely difficult to achieve good vision with such stick-on lenses.

In U.S. Pat. No. 6,196,678, safety glasses are shown with a near-point corrective lens forming the entire lower portion of a safety shield. The safety shield is either unitary, with two corrective lenses forming the entire lower portions of the left and right sides of the shield, or alternately the shield is in two pieces with one corrective lens forming the entire lower portion of each shield piece. These protective shields are not curved to follow the contour of the wearer's face, and additional side shields are attached to temples to partially close the gap between the safety shield(s) and the wearer's face. The provision of corrective lenses as the entire lower portion of the safety shield also unnecessarily compromises peripheral vision, as the wearer primarily needs only straight ahead corrected vision to focus on a unit of work.

Accordingly, there is a need for reading safety glasses that provide all of the protection of standard safety glasses and provide vision correction for reading and close work.

### SUMMARY OF THE INVENTION

It is a principal object the invention herein to provide safety glasses with a correction for reading and close work.

It is a further object of the invention to provide reading safety glasses with good corrective abilities.

It is another object of the invention herein to provide reading safety glasses that have a good protective capability with respect to the flying debris.

In carrying out the foregoing objects of the invention, reading safety glasses are provided with a one-piece unitary lens having a left eye plano-convex portion and a right eye plano-convex portion, the left eye plano-convex portion and the right eye plano-convex portion each having an independent radius of curvature. According to one aspect of the invention, the radii of curvature of the left eye plano-convex portion and right eye plano-convex portion are the same. Left eye and right eye corrective lens segments are respectively integrally formed in and surrounded by the left eye plano-convex portion and the right eye plano-convex portion, and a frame is provided for receiving and holding the lens and for supporting the safety glasses on the wearer's face.

According to further aspects of the invention, the left eye plano-convex portion and the right eye plano-convex portion are connected by a bridge. The radii of curvature of the left eye plano-convex portion and the right eye plano-convex portion are in a range from generally about 5 diopters to generally about 8 diopters, and preferably about 6 diopters.

Also, according to additional aspects of the invention, the corrective lens segments provide vision correction in the range of about 0.5 to 4 diopters. The corrective lens segments are generally semicircular and are positioned in front of the wearer's eyes with a substantially straight upper edge of the corrective lens segments, providing normal vision over the corrective lens segments.

In accordance with other aspects of the invention, the lens is molded of polycarbonate material. The lens is molded with integral side shields, and the frame is attached across the top edge of the lens, including integral side shields, with temple pieces leading from the side shields to the ears. A nose piece is provided below the bridge connecting the left plano-convex portion and the right plano-convex portion, for supporting the reading safety glasses on the wearer's nose.

Other and more specific objects and features of the invention herein will in part appear from a perusal of the following detailed description and claims, taken together with the drawings.

### BRIEF DESCRIPTION OF DRAWINGS

FIG. 1 is a perspective view of reading safety glasses according to the invention herein, shown on a wearer;

FIG. 2 is a front elevation view of the lens of the reading safety glasses of FIG. 1;

FIG. 3 is a side elevation view of the reading safety glasses of FIG. 1; and

FIG. 4 is a view of the top edge of the lens of the ready safety glasses of FIG. 1, looking down on FIG. 2.

The same reference numerals refer to the same elements throughout the various figures.

### DETAILED DESCRIPTION OF PREFERRED EMBODIMENT

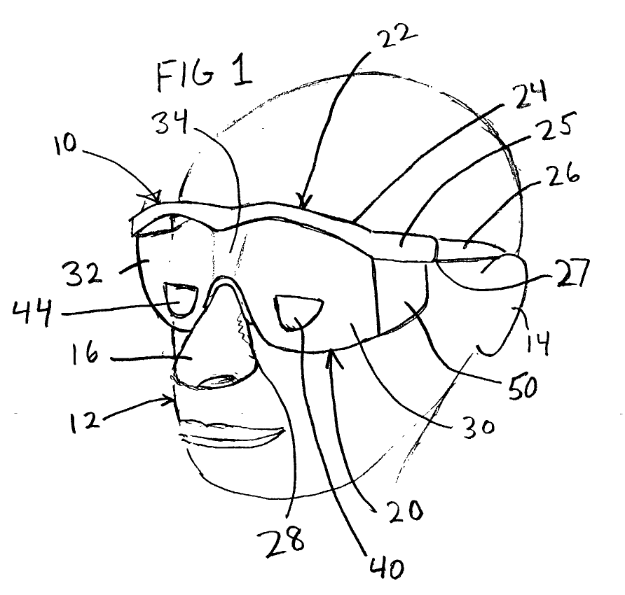

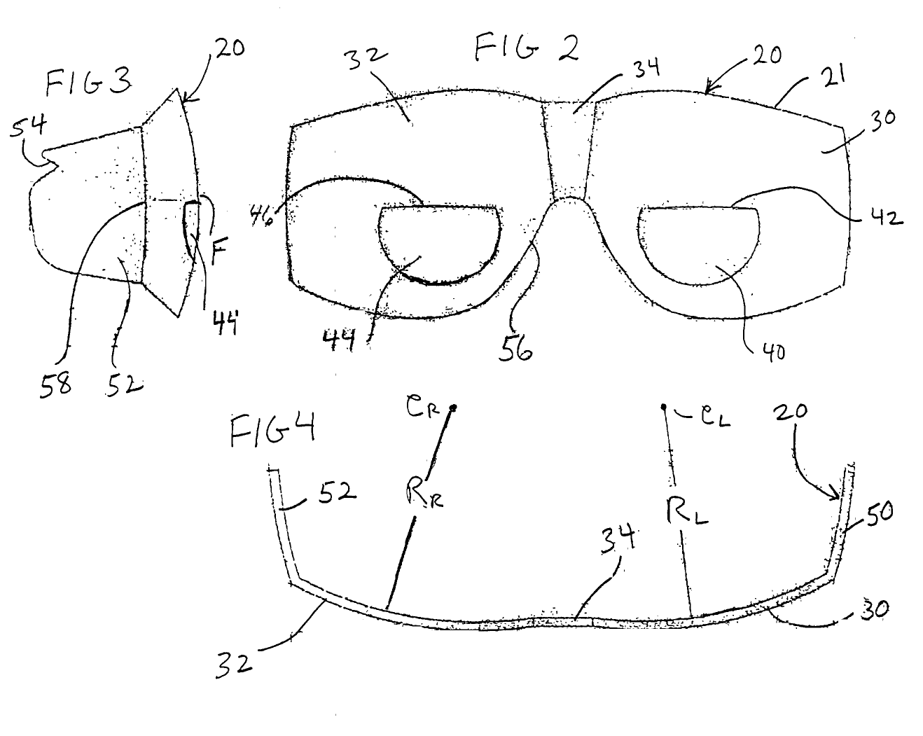

With reference to FIG. 1, reading safety glasses 10, according to the invention herein, are shown on the face 12 of a user. The reading safety glasses 10 have a lens 20, which is illustrated in FIGS. 2-4. The lens 20 is attached to and supported on a frame 22, consisting of a top piece 24 secured to a top edge 21 of the lens 20 and temples 26, one of which is seen in FIG. 1. The temples 26 fit over the ears 14 of the user. The frame 22 may alternatively be provided in two top piece frame elements respectively secured to each side of the lens, for connecting the lens and the temples. The top piece frame elements may comprise a portion of hinges connecting the lens and temples, and the term “frame” as used herein is intended to embrace such various frame elements. The lens 20 is also supported on the nose 16 of the wearer, with a nose piece 28 resting directly on the nose 16.

With reference to FIGS. 2-4, the lens 20 has a left eye plano-convex portion 30 and a right eye plano-convex portion 32, which are integrally joined by bridge 34. As perhaps best seen in FIG. 4, each of the left eye plano-convex portion and right eye plano-convex portion 30 and 32 has its own radius of curvature R_{L} and R_{R}. That is, the left and right portions respectively have centers C_{L} and C_{R}, which are spaced apart. The preferred radius of curvature is generally about 6 diopters for both the left eye and right eye portions 30, 32, and both the front and rear surfaces of the lens portions 30, 32 are provided with substantially the same radius of curvature, so that the lens portions 30, 32 are plano-convex. The radius of curvature for each plano-convex portion 30, 32 may be in the range of from generally about 5 diopters to generally about 8 diopters, and is preferably about 6 diopters. It should also be noted that the plano-convex portions do not have to be precisely spherical, and in particular may vary from a precisely spherical shape to better conform to a wearer's face, and this is intended to be included in the description of the portions 30, 32 as being “plano-convex.”

The left eye plano-convex portion 30 has a corrective lens segment 40, which is generally semicircular in shape with a straight upper segment edge 42. The corrective insert is integrally formed with the lens 20, and is provided in a corrective power suitable for improving reading and close work ability. Thus, the corrective lens segment 40 may typically be provided with a power of from about 0.5 to about 4 diopters, in increments of 0.5 diopters. It will be appreciated that all of these diopters are not available in an individual lens, but that a plurality of lenses 20 are individually manufactured and made available with a selection of diopter powers of the corrective lens segments.

The right eye plano-convex portion 32 is also provided with a corrective lens segment 44, which is also of generally semicircular configuration with a flat or straight upper segment edge 46. The corrective lens segment 44 is generally provided in the same corrective power as the left corrective lens segment 40 in a particular lens 20. The corrective lens segments 40, 44 are positioned generally below the center of the plano-convex portions 30, 32, and are relatively small with respect to the plano-convex portions 30, 32, such that the corrective lens segments 40, 44 are respectively surrounded by the plano-convex portions 30, 32. This configuration and sizing facilitates molding the corrective lens segments integrally with the curved plano-convex portions, and thereby also enables lens 20 to be shaped with minimal gaps between it and the wearer's face.

The lens 20 also has side shields 50 and 52, which are integral with the left and right plano-convex portions 30 and 32, respectively. With reference to FIG. 3, the side shield 52 is notched at 54, for attachment to the top piece 24 of the frame 22, the top piece 24 having rearwardly extending portions 25 that receive the upper edges of the side shields. The temples 26 are preferably hingedly attached to the top piece 24 at hinges 27. The lens 20 defines a nose arch 56 below the bridge 34, and the nose piece 28 is fitted onto the edge of the lens 20 in the area of the nose arch 56.

The lens 20 is preferably molded of polycarbonate which is an exceptionally strong and shatter-resistant plastic. Other hard shatterproof polymers may be used. Because of the tendency of polycarbonate to scratch, it is generally provided with an anti-scratch coating, as is known to those skilled in the art. The frame 22 and nose piece 28 are preferably fabricated of nylon or any suitable high strength comfortable plastic.

With reference to FIG. 3, it can be seen that the front of the lens portion 32, indicated at F, is positioned well forward of the side edge 58, where the right eye lens portion 32 and side shield 52 are integrally joined. This illustrates that the curvature of the right eye plano-convex lens 20 portion permits the lens to hug the cheek of the wearer, minimizing the gap between the wearer's cheek and the lens in order to protect against flying debris. The left eye plano-convex portion is similarly curved and protective, as may also be seen in FIG. 1.

Accordingly, there has been described reading safety glasses which admirably fulfill the object of the invention herein. Those skilled in the art will appreciate that various changes and modifications may be made without departing from the spirit and scope of the invention, which is limited only by the following claims.

1. Safety glasses comprising:
A) a one-piece unitary lens having a left eye plano-convex portion and a right eye plano-convex portion, the left eye plano-convex portion and the right eye plano-convex portion each having an independent radius of curvature, said lens having an upper edge;
B) a left eye corrective lens segment integrally formed in the left eye plano-convex portion and a right eye corrective lens segment integrally formed in the right eye plano-convex portion; and
C) a frame receiving and holding the one-piece unitary lens, and adapted to support the lens on a wearer's face with the corrective lens segments positioned for reading and close work:

2. Safety glasses as defined in claim 1 wherein the left eye and right eye corrective lens segments are surrounded by their respective left eye and right eye plano-convex portions.

3. Safety glasses as defined in claim 2 wherein the corrective lens segments have a generally semi-circular configuration with straight upper segment edges.

4. Safety glasses as defined in claim 3 wherein the corrective lens segments have power in the range of 0.5 to 4 diopters.

5. Safety glasses as defined in claim 3 wherein the left eye plano-convex portion and the right eye plano-convex portion are connected by a bridge.

6. Safety glasses as defined in claim 5 wherein the curvatures of the left eye plano-convex portion and the right eye plano-convex portion are in a range of from about 5 diopters to about 8 diopters.

7. Safety glasses as defined in claim 6 wherein the curvatures of the left eye plano-convex portion and the right eye plano-convex portion are approximately 6 diopters.

8. Safety glasses as defined in claim 5 and further comprising:
D) a first side shield integrally formed with and extending from the left eye plano-convex portion and a second side shield integrally formed with and extending from the right eye plano-convex portion.

9. Safety glasses as defined in claim 8 wherein the frame has a top piece extending across the upper edge of the lens, including extending along the first and second side shields, and the frame further comprises first and second temples hingedly connected to the top piece respectively adjacent the first and second side shields.

10. Safety glasses as defined in claim 1 wherein the one-piece unitary lens is formed of molded polycarbonate.

11. Safety glasses as defined in claim 1, wherein the radii of curvature of the left eye plano-convex portion and the right eye plano-convex portion are in a range of from about 5 diopters to about 8 diopters.

12. Safety glasses as defined in claim 11 wherein the radii of curvature of the left eye plano-convex portion and the right eye plano-convex portion are approximately 6 diopters.

13. Safety glasses as defined in claim 1 wherein the left eye plano-convex portion and the right eye plano-convex portion are connected by a bridge.

14. Safety glasses as defined in claim 1 and further comprising:
D) a first side shield integrally formed with and extending from the left eye plano-convex portion and a second side shield integrally formed with and extending from the right eye plano-convex portion.

15. Safety glasses as defined in claim 14 wherein the frame has a top piece extending across the upper edge of the lens, including extending along the first and second side shields, and the frame further comprises first and second temples hingedly connected to the top piece respectively adjacent the first and second side shields.

16. Safety glasses as defined in claim 1 wherein the one-piece unitary lens is formed of molded polycarbonate.

17. Safety glasses as defined in claim 1 wherein the lens is shaped to minimize the gap between the lens and the wearer's face.
